(19) United States
(12) Patent Application Publication
(10) Pub. No.: US 2015/0094023 A1
(43) Pub. Date: Apr. 2, 2015

(54) Retroactively Securing a Mobile Device From a Remote Source

(71) Applicant: Google Inc., Mountain View, CA (US)

(72) Inventors: Andrew Abramson, Sunnyvale, CA (US); Benjamin Poiesz, Santa Clara, CA (US)

(73) Assignee: Google Inc., Mountain View, CA (US)

(21) Appl. No.: 14/042,944

(22) Filed: Oct. 1, 2013

(51) Int. Cl. H04W 12/06

(52) U.S. Cl. CPC H04W 12/06
USPC 455/411

(57) ABSTRACT

Described is a technique for retroactively securing a mobile device from a remote source. A user may remotely lock the bootloader of the device from a device management portal. Accordingly, a user may essentially “brick” the device rendering the device unusable by another user until an additional security check is passed. The ability to remotely lock the device may be provided in response to a notification of a potentially unauthorized access of the device. The unauthorized access may include a reset or wipe of the device. Accordingly, the technique provides the ability of an authorized user to secure the mobile device even after being maliciously disassociated from the device.

### BACKGROUND

A mobile device often has the ability to protect data stored on the device when it is lost or stolen. For example, the mobile device may have an access control such as a password lock or other technique for securing the device. In addition, some devices allow for a user to track and/or locate the device. Even with these capabilities, however, a device may be reset or wiped, and access controls and/or location detecting software on the device may be removed. In addition, efforts to maintain registries of blacklisted devices based on the International Mobile Station Equipment Identity (IMEI) number of the device are not always effective because service providers on different continents may subscribe to different registries. As a result, a blacklisted device may still be valuable to a reseller of misappropriated devices especially when the devices can be shipped and used overseas. Accordingly, the techniques described above may provide some level of protection for securing data on the device, but often do not provide the desired level of theft deterrence.

### BRIEF SUMMARY

In an implementation, described is a method of remotely securing a mobile device. The method may include determining a potential unauthorized access of the mobile device and sending, to a first user, a notification of the potential unauthorized access. The potential unauthorized access may include a removal of the first user as an authorized user of the mobile device. The potential unauthorized access may also include adding a second user as the authorized user. In addition, the potential unauthorized access may include a resetting of the mobile device or wiping a storage of the mobile device. The method may include receiving, from the first user, a confirmation of an unauthorized access. The confirmation may be received within a predefined time period of sending the notification and the confirmation may require authenticating the first user at a device management portal. The method may include sending, to the mobile device and in response to the confirmation, an instruction that locks a bootloader of the mobile device. The bootloader of the mobile device may be provided by a first entity that manufactured the mobile device, and an operating system of the mobile device may be provided by a second entity that remotely secures the mobile device. The instruction that locks the bootloader of the mobile device may override an access control by an operating system of the mobile device. In addition, the instruction may occur while the mobile device is in a secure state set by an operating system of the mobile device. The secure state may include encrypting a storage of the mobile device. The method may also include determining the first user based on an authorized user prior to the potential unauthorized access. In addition, an authorization to send the instruction that locks the bootloader of the mobile device may be enabled for the first user and disabled for all other users. The authorization may also be disabled for the first user after the predefined time period. The method may also include determining that the mobile device is in a powered-off state, and the instruction that locks the bootloader of the mobile device may be sent upon the mobile device entering a powered-on state and connecting to a network.

In an implementation, described is a system for remotely securing a mobile device. The system may include a database storing usage information of the mobile device and a server coupled to the database. The server may include a processor, and the processor may be configured to determine a potential unauthorized access of the mobile device based on the stored usage information. The processor may send, to a first user, a notification of the potential unauthorized access and receive, from the first user, a confirmation of an unauthorized access. The confirmation may be received within a predefined time period of sending the notification. The processor may also send, to the mobile device and in response to the confirmation, an instruction that locks a bootloader of the mobile device. The processor may also determine that the mobile device is in a powered-off state and store the instruction that locks the bootloader of the mobile device in the database. The instruction that locks the bootloader of the mobile device may be sent upon determining that the mobile device is in a powered-on state and connected to a network.

In an implementation, described is a method of remotely securing a mobile device. The method may include authenticating, at a device management portal, a first user of the mobile device. The method may include receiving, from the first user, a request to lock the mobile device. The method may also include sending, to the mobile device and in response to the request, an instruction that locks a bootloader of the mobile device. The method may include determining the first user has authorization to send the instruction that locks the bootloader of the mobile device and the instruction that locks the bootloader of the mobile device may override an access control by an operating system of the mobile device.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 illustrates a block diagram of a server according to an implementation of the disclosed subject matter.

FIG. 2 illustrates an example network arrangement according to an implementation of the disclosed subject matter.

FIG. 3 illustrates a block diagram of a device according to an implementation of the disclosed subject matter.

FIG. 4 illustrates an example flow diagram of remotely securing a mobile device after a potential unauthorized access according to an implementation of the disclosed subject matter.

FIG. 5 illustrates an example flow diagram of remotely securing a mobile device to prevent an unauthorized access according to an implementation of the disclosed subject matter.

FIG. 6 illustrates an example display of a device that has been locked according to an implementation of the disclosed subject matter.

FIG. 7 illustrates an example display of a device that has been locked and provides a notification message according to an implementation of the disclosed subject matter.

### DETAILED DESCRIPTION

Described is a technique for retroactively securing a mobile device from a remote source. In an implementation, a user may initiate an instruction from a remote source in order to secure a device. More specifically, a user may remotely lock the bootloader of the device from a device management portal. Locking the bootloader of a device allows a user to essentially “brick” the device. By locking the bootloader, the device may be rendered unusable by another user until an additional security check is passed. For example, if the bootloader is locked, the device may not be accessed without the appropriate passcode. Moreover, the device may be locked even in instances where the device has been wiped or reset because the lock may be provided at the bootloader level.

In addition, the technique describes the ability to retroactively lock the mobile device even after the device has been misappropriated. When a device is stolen, a thief may immediately attempt to disassociate the authorized user (e.g. legitimate owner) from the device in order to prevent the authorized user from remotely securing the device. For example, a thief may connect the device (e.g. smartphone) to another device (e.g. computer) and utilize software tools to wipe or reset the device. In an implementation, a server may determine that the device has been wiped or reset, and in response, notify a user of the potentially unauthorized access of the device. Upon receiving the notification, the user may initiate an instruction to lock the device remotely from a device management portal (e.g. website). Accordingly, the server may provide the ability for the disassociated user to still perform device management functions under certain conditions because the server may determine the user was authorized prior to the malicious disassociation. For example, a previously authorized user may be authenticated at the device management portal and provided with the ability to send an instruction to lock the device if such a command is issued within a predefined time window of the malicious activity. Thus, the techniques described herein allow a user to retroactively and remotely “brick” the device, and thus, potentially provide a strong deterrent to theft.

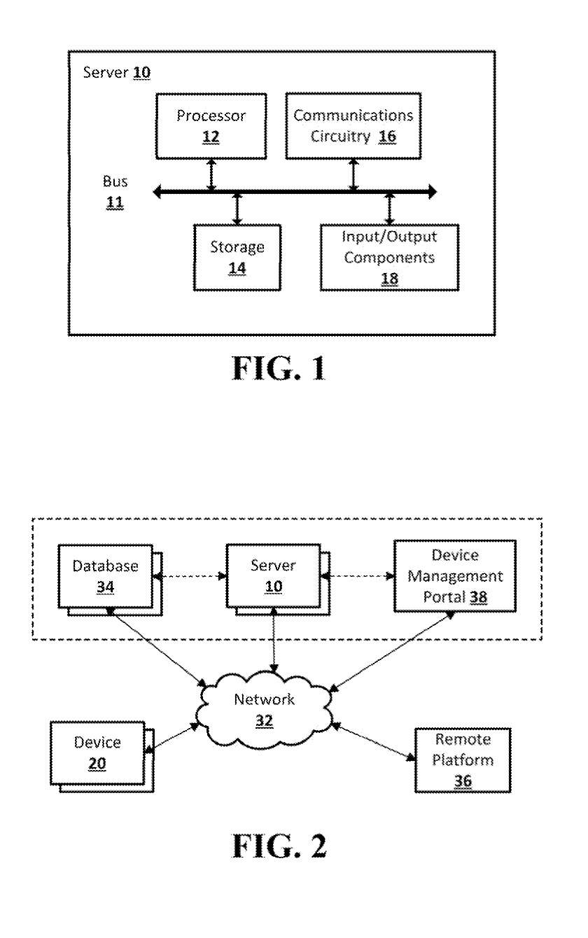

FIG. 1 illustrates a block diagram of a server according to an implementation of the disclosed subject matter. The server 10 may be part of a remote service such as a cloud-based service, and may include a system of networked servers (and databases) in addition to a single server. The server 10 may include a bus 11 which interconnects major components of the server 10, such as a processor 12, a storage 14, communications circuitry 16, and input/output components 18.

The processor 12 may be any suitable programmable control device and may control the operation of one or more processes, such as account management and user authentication as discussed herein, as well as other processes performed by the server 10. The storage 14 may be integral with the server 10 or may be separate and accessed through an interface. The storage 14 may store content, software (e.g., for implementing various functions on server 10), and other data. The storage 14 may include any suitable storage medium, such as one or more hard-drives, solid state drives, flash drives, and the like. The server 10 may also include one or more databases as described further herein.

The input/output components 18 may include output components and interfaces for a display that provides visual output. The input/output component may also include input components and interfaces for user input devices that allow a user to interact with the server 10. For example, the user input devices may include a keyboard, a keypad, a mouse, touchpad, a touch screen, and the like. The communications circuitry 16 may include one or more interfaces to allow the server 10 to communicate with other servers 10, devices 20, and databases 34 via one or more local, wide-area, or other networks as shown in FIG. 2. In addition, the server 10 may include various high-speed interfaces such as fast Ethernet interfaces, Gigabit Ethernet interfaces, ATM interfaces, HSSI interfaces, POS interfaces, FDDI interfaces and the like. These interfaces may include ports appropriate for communication with the appropriate media, and in some cases, may include an independent processor to control communications intensive functions.

FIG. 2 illustrates an example network arrangement according to an implementation of the disclosed subject matter. Implementations may include one or more devices 20 which may include or be part of a variety of computing devices such as a mobile device including a mobile phone or “smartphone,” tablet, laptop, netbook, personal digital assistant (“PDA”), media device, watch, and other types of devices. The device 20 may communicate with other devices 20, servers 10, databases 34, and a device management portal 38 via the network 32. The database 34 may be part of or coupled to the server 10.

The network 32 may be a local network, wide-area network (including the Internet), and other suitable communications network. The network 32 may be implemented on any suitable platform including wired and wireless technologies. For example, the server 10 may communicate with the device 20 using one of the 802.11 standards, and/or other wireless network technologies including the Global System for Mobile Communications (GSM), and Code Division Multiple Access (CDMA) based protocols.

The server 10 may be directly accessible by the device 20, or one or more other devices 20 may provide intermediary access to a server 10. The server 10 may also be part of or coupled to a device management portal 38 as described further herein. The device 20 and server 10 may access a remote platform 36 such as cloud computing arrangement or service. The remote platform 36 may also include one or more servers 10, databases 34, and the device management portal 38. The term server may be used herein and may include a single server or a system of servers including one or more databases 34 and the device management portal 38. For example, a server 10 may include one or more servers responsible for managing devices and user accounts and interfacing with a user through the device management portal 38.

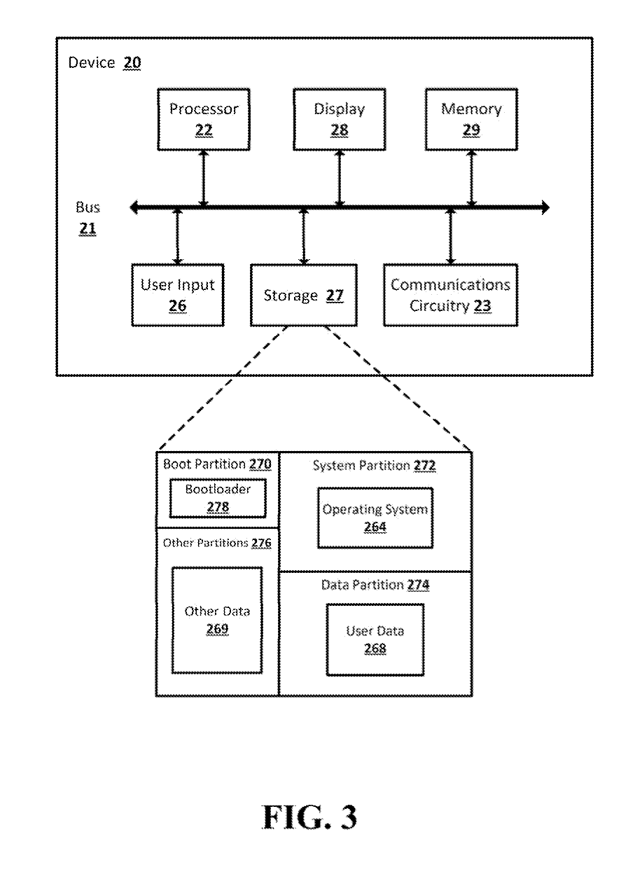

FIG. 3 illustrates a block diagram of a device according to an implementation of the disclosed subject matter. The device 20, which may include a mobile device as described above, may include a bus 21, processor 22, user input 26, display 28, communications circuitry 23, storage 27, and memory 29. The bus 21 may provide a data transfer path for transferring between components of the device 20. The display 28 may provide visual output and may include a touch-sensitive screen. The user input 26 may allow a user to interact with the device 20. For example, the user input 26 may include buttons, a keypad, a touch screen, microphone, and the like.

The communications circuitry 23 may include circuitry such as a radio for wireless communications for short-range and/or long range communication. For example, the wireless communication circuitry may include circuitry for connecting to a network. The network may include a cellular network utilizing suitable protocols such as (GSM) and (CDMA) based wireless protocols. The communication circuitry 23 may also include Wi-Fi enabling circuitry for one of the 802.11 standards and circuitry for any other wireless network protocols. For example, the mobile device (e.g. a tablet) may not necessary include cellular calling capabilities, but may include Wi-Fi enabling circuitry for connecting to a network such as the internet. Communications circuitry 23 may also include circuitry that enables the device 20 to be electrically coupled to another device (e.g. a computer or an accessory device) and communicate with that other device.

The device 20 may be battery-operated and portable so as to allow a user to communicate with others, listen to music, play games or video, record video, take pictures, or control other devices. The device 20 may be relatively compact which enables a user to easily manipulate the device's position, orientation, and movement. Accordingly, the device 20 may provide techniques of sensing such changes in position, orientation, and movement to enable a user to interface with or control the device 20 by affecting such changes. Further, the device 20 may include a vibration source, under the control of processor 22, for example, to facilitate sending motion, vibration, and/or movement information to a user related to an operation of the device 20.

The memory 29 may include any suitable type of memory such as cache, Random-Access Memory (RAM), Read-Only Memory (ROM) including erasable programmable read only memory (EPROM), electrically erasable programmable read-only memory (EEPROM), Flash ROM, and the like. The RAM may store instructions loaded during a startup of the device.

The storage 27 may include any suitable types of storage. The storage 27 may store content (e.g. email message, multimedia, photos, etc.), software including an operating system and other suitable data. The storage 27 may include a hard-drive, solid state drive, flash drive, and the like. In addition, the storage 27 may be integral with the device 20 or may be separate and accessed through an interface to receive a memory card, USB drive, and the like. As shown, the storage 27 may include one or more partitions.

The partitions may include a boot partition 270, a system partition 272, a data partition 274, and one or more other partitions 276. The boot partition 270 may include modules reserved for boot functions such as a bootloader 278. The system partition 272 may include an operating system 264. The operating system 264 may include, for example, a collection of software modules that manage device resources and provides common services for applications. The device may include one or more operating systems, but in some instances, may include only one operating system. Typically, the system partition 272 may be administered as read-only for security reasons and to prevent corruption of important system modules.

The data partition 274 may store user data 268. This user data 268 may be modified often and may be completely reformatted, deleted, wiped, reset, and the like without removing the operating system 264. Accordingly, the data partition 274 may be administered as read-write. User data 268 may include content that is stored on the device such as email messages, multimedia, photos, etc. and applications that the user has installed on the device. For example, in an implementation, the user data may include substantially all data stored on the device not including an operating system 264 and system modules. In another example, user data 268 may include data stored on the device by the user. In other words, user data 268 may not include the operating system 264, which may be provided by a platform provider, and system modules such as the bootloader 278, which may be provided by a manufacturer of the device. In yet another example, user data 268 may include data stored on portions or partitions of the storage intended be accessible and/or writeable (e.g. read-write) by a user.

Other partitions 276 may include partitions for other data 269. For example, a partition reserved for system recovery may store a backup version of an operating system during an upgrade. Other data 269 may include other forms of data such as temporary data, and recovery data, and the like. The system partition 272 and the other partitions 276 may or not be accessible by a user. For example, a user may not be able to read or write on these partitions if it is not intended to be accessible to a user. It should be noted that the partitions shown in FIG. 3 are just examples and other partitions and/or configurations may also be used. For example, an operating system 264 and user data 268 may be stored on the same partition. In another example, the bootloader 278 may be stored on an additional storage and/or memory that is distinct from the storage including, for example, an operating system 264 and/or user data 268.

The device 20 may be associated with one or more user accounts. These accounts may include a single account such as a primary user account, and/or other types of accounts such as an administrative user type account. These accounts may be defined during an initialization of the device (e.g. upon purchasing the device, or upon configuring the device with a carrier such as a cellular service provider), or at another point in time. The user account information may be stored on the device or in a remote location such as on the server 10, which may include the device management portal 38. In an implementation, an authorized user of the device may be determined based on the user account associated with the user. For example, an authorized user may be determined based on the device requiring a primary user account. As mobile device are often viewed as “personal,” the device may be limited to a single authorized user at a time. An authorized user may be authorized to perform device management functions such as configuring settings of the device. The functions may be performed directly on the device and/or through a central website such as the device management portal 38. Typically, in order to perform device management functions remotely, a user must first be authenticated such as by logging into the user account. A user may access the device management portal 38 through a website or a specific application for accessing the portal.

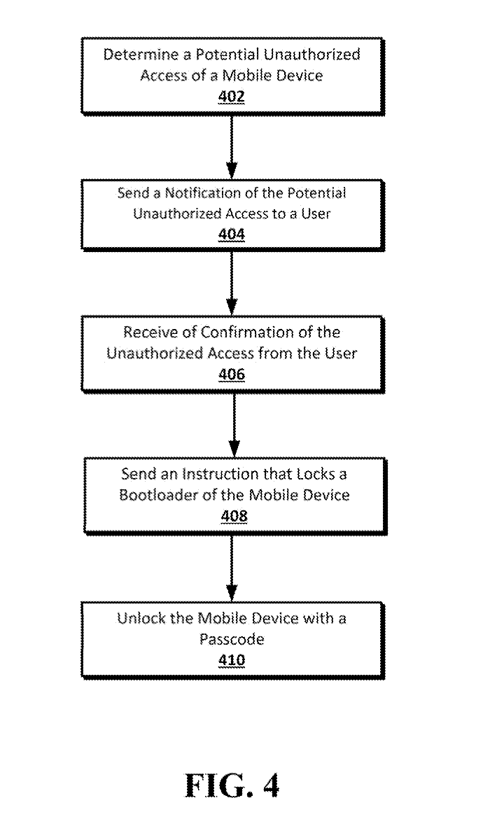

FIG. 4 illustrates an example flow diagram of remotely securing a mobile device after a potential unauthorized access according to an implementation of the disclosed subject matter. In 402, a server (e.g. server 10) may determine a potential unauthorized access of a mobile device (e.g. device 20). The potential unauthorized access may be determined based on information received from the device. This information may include usage information and/or information related to a user account that may be associated with the device. This may include detecting certain suspicious activities or other actions that may create a potential vulnerability on the device. For example, a reset of the device may be deemed a potential unauthorized access. As referred to herein, a reset may include restoring the device to its original factory settings, removing and/or reinstalling an operating system, and like type operations. In another example, wiping the device may be deemed as a potential unauthorized access. As referred to herein, wiping the device may include reformatting, deleting, erasing, clearing, scrubbing, or like type operation on one or more storages and/or partitions of the device.

A potential unauthorized access may also include removal or changes to a user account and/or an authentication procedure. This may include deleting, disabling, or removing a user account, resetting a password, creating an additional authorized user, or any other action that may prevent a legitimate authorized user from accessing the device. As described above, when a device is misappropriated, the unauthorized user (e.g., a thief) may attempt to reset the device to limit the possibility of the authorized user detecting a theft, determining the location of the device, remotely securing the device, or any other action they may prevent the unauthorized user from accessing the device. For example, mobile devices often have an application for locating a lost device, and accordingly, a thief may attempt to remove such an application.

Another potential unauthorized access may include determining an unusual or suspicious device usage pattern. For example, a server may determine usage patterns such as excessive long distance calling or other activity that may be unauthorized. In addition, in situations where the mobile device may be used as a standalone payment device (e.g. purchasing technologies through near-field communication techniques), unusual and/or suspicious purchasing patterns may give rise to a suspected misappropriation of the device. In another example, the authorized user may indicate that the device has been misplaced as of particular point of time. For example, if the user misplaced the device several hours ago, but the device has been used within the last hour, a potential unauthorized access may be determined.

In 404, the server may send a notification of the potential unauthorized access to the user. This notification may be sent from the server directly, or through a management portal (e.g. device management portal 38). The notification may include a suitable technique for communicating with the user such as email, text message, a notification through a website, and other suitable technique. For example, the notification may be sent to an email address associated with the user account of the authorized user. This email address may be associated with the user upon initializing a user account. In an implementation, the entity that provides the server may be a platform and services provider. Accordingly, the entity may provide a platform (e.g. an operating system) for operating a mobile device as well as services such as issuing and managing email accounts including the email account associated with the user. Thus, the entity may integrate or use the same user account across multiple services.

In 406, the server may receive a confirmation of the unauthorized access from the user. The user may receive the notification (e.g. via email) and provide a confirmation that the potential unauthorized access was in fact unauthorized. Alternatively, the user may indicate that the access was authorized. For example, the authorized user themselves may have reset the device. The confirmation of the unauthorized access may require the user to perform some form of authentication. For example, the device management portal may require the user to login to a user account in order to confirm or negate the potential unauthorized access. When providing a confirmation of an unauthorized access, the legitimate authorized user (e.g. the authorized user prior to being maliciously dissociated from the device) may be required to respond within a predefined time window of the unauthorized access or the notification. This policy may be enforced as the server may retroactively lock the device even if the legitimate authorized user has been removed or disassociated with the device (presumably by an unauthorized user). For example, the legitimate authorized user may be required to confirm the unauthorized access within 24 hours in order to lock the device retroactively. By limiting the availability of the lock instruction to the predefined time window, the device may attempt to tailor the lock ability to instances of device misappropriation as opposed to being locked arbitrarily.

In 408, the server may send an instruction that locks a bootloader of the mobile device. This instruction may be sent in response to the confirmation received in 406. The instruction may be sent through any suitable technique for communicating with the device. For example, a mobile device may receive the instruction through a network such as via a cellular communications network. The instruction to lock the bootloader may be performed by software and/or firmware of the mobile device that resides on a lower portion of the stack than the operating system. For example, the bootloader 278 may be locked by a module residing on the boot partition 270. In another example, a module may reside on another partition separate from the partition that stores the operating system 264. Accordingly, even if the operating system is in a secure state, the instruction may override such a state and lock the device at the bootloader level. Thus, even if an unauthorized user has the tools to reset or circumvent controls of the operating system, the bootloader may render the device unusable. A secure state may include requiring an authentication to access the device. For example, the authentication may include a password lock, a biometric lock, or the like. In addition, the secure state may include encrypting data on the device. For example, one or more storages may be encrypted, which may include encrypting one or more partitions of the device. For example, a data partition 274 including user data 268 such as applications, emails, media content, etc., may be encrypted. In such a scenario, an operating system and/or a bootloader may be stored on one or more separate partitions. For example, an operating system 264 may be stored on a system partition 274, and the bootloader 278 may be stored on a boot partition 270.

The instruction for locking the device may include sending a passcode to a module on the boot partition 270 that is responsible for administering the lock. For example, the passcode may include a cryptographic PIN that is randomly generating and of a certain length (e.g. at least 8 digits) to prevent a trivial unlock of the device. In some instances, the bootloader 278 of the mobile device may be provided by an entity that manufactured the mobile device. This entity may be different than the entity that provides an operating system for the device. In addition, the entity that provides the operating system may also provide the one or more servers, which may include the device management portal, for remotely securing the device. When the device is in a locked state, certain modules may be available to provide minimum functionality. For example, modules to provide a display and the ability to enter the passcode may be necessary. In addition, a rudimentary communications module may be available in order to make an emergency (e.g. 911) call even when the bootloader is locked in order to comply with certain mobile communications regulations.

When sending the instruction, the device may be powered-off, and accordingly, may not be in a state to receive communications including the lock instruction. For example, a thief may immediately power-off the device (or remove the battery) upon a misappropriation. In such a situation, the instruction may be cached such that the instruction is sent upon the mobile device entering a powered-on state and connecting to a network (e.g. network 32). This instruction may be cached for an indefinite period of time and provides an additional layer of security. For example, regulatory requirements that attempt to limit resellers from stocking misappropriated devices may require resellers to, at a minimum, power-on the device for verification. Upon entering a powered-on state, the locked status of the device (along with a possible notification message) provides an indication to the reseller that the device is not suitable for resale. Thus, this added feature provides an additional hurdle for reselling misappropriated devices.

In 410, a user may unlock the mobile device with the appropriate passcode. The passcode generated in 408 may be shared with the user upon an authentication procedure. In an implementation, the user may login to the device management portal and retrieve the passcode for unlocking the device.

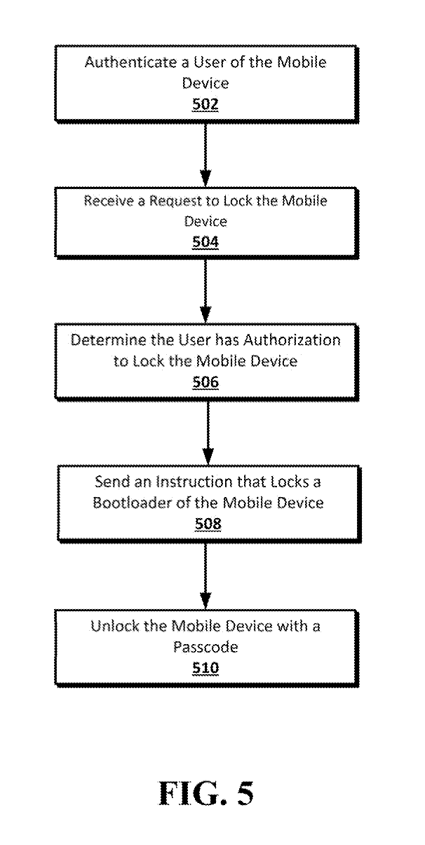

FIG. 5 illustrates an example flow diagram of remotely securing a mobile device to prevent an unauthorized access according to an implementation of the disclosed subject matter. In addition to receiving a notification of a potential unauthorized access, a user may lock the device to prevent a potential unauthorized access. For example, if a user loses their mobile device, the user may wish to lock the device in order to prevent another user from wiping or resetting the device. In 502, the server may authenticate the user. This authentication may occur at the device management portal as described above. In 504, the user may request to lock the mobile device. This may include submitting a request on at the device management portal. In 506, the server may determine if the user has authorization to lock the mobile device. For example, the lock function may be limited to a primary user account and the server may determine if the user is associated to the primary account. In 508, the server may send an instruction to lock the bootloader of the device. The instruction may be sent in similar manner as described above in 408. In 510, the user may unlock the device with a passcode as described above in 410.

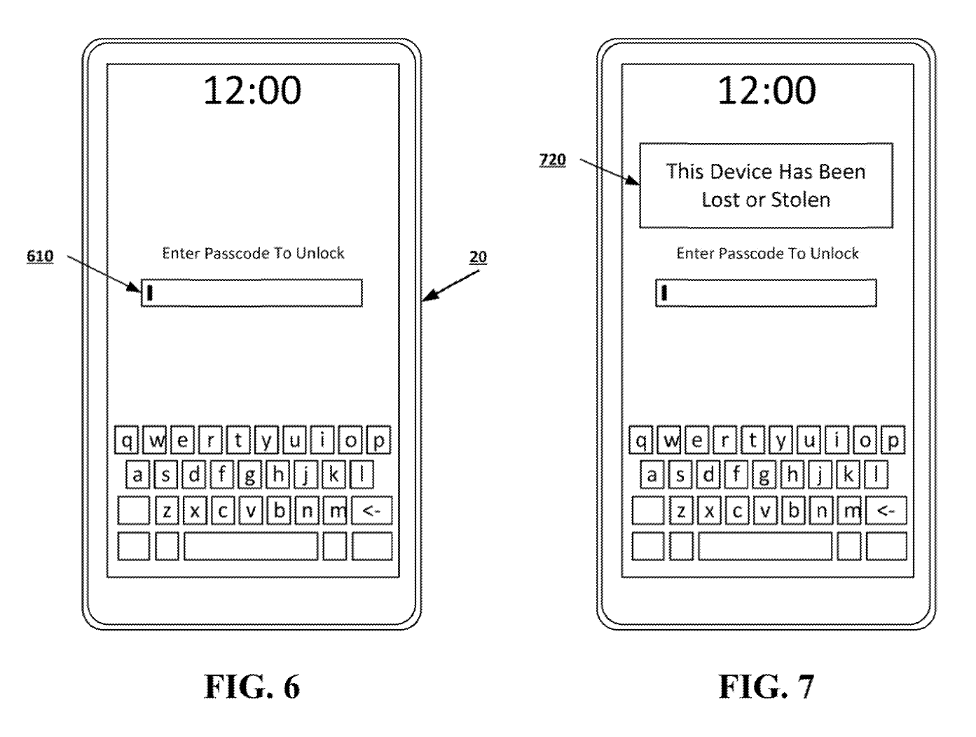

FIG. 6 illustrates an example display of a device that has been locked according to an implementation of the disclosed subject matter. As shown, the user may be provided a prompt 610 for entering the appropriate passcode. Upon entering the passcode, the user may boot the device and resume use of the mobile device functions. In addition, the passcode requirement to boot the device may now be removed.

FIG. 7 illustrates an example display of a device that has been locked and provides a notification message according to an implementation of the disclosed subject matter. In an implementation, the device may also display a particular message 720 as shown when the device is in a locked state. For example, the device may include a notification that the device has been flagged as lost or stolen. This notification message may act as an additional theft deterrent by diminishing the ability to resell the device. In addition, a notification message may also appear on a display of the device indicating the device is no longer locked. This notification may also provide a verification process for a legitimate owner to sell the device. For example, upon reselling the device, the legitimate owner (e.g. authorized user) may reset the device, which may trigger the potential unauthorized access notification. When confirming the reset was authorized, the user may specify including a display message on the device confirming the reset was authorized. Thus, a potential buyer may confirm the legitimacy of the transaction by the displayed notification message. Accordingly, as described above, the additional security features that may be implemented on the device may create additional layers of theft deterrence.

Various implementations may include or be embodied in the form of computer-implemented process and an apparatus for practicing that process. Implementations may also be embodied in the form of a computer-readable storage containing instructions embodied in non-transitory and/or tangible memory and/or storage, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, structure, or characteristic, but every implementation may not necessarily include the particular step, feature, structure, or characteristic. Moreover, such phrases are not necessarily referring to the same implementation. Further, when a particular step, feature, structure, or characteristic is described in connection with an implementation, such step, feature, structure, or characteristic may be included in other implementations whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method of remotely securing a mobile device, comprising:
determining a potential unauthorized access of the mobile device;
sending, to a first user, a notification of the potential unauthorized access;
receiving, from the first user, a confirmation of an unauthorized access, the confirmation received within a predefined time period of sending the notification; and
sending, to the mobile device and in response to the confirmation, an instruction that locks a bootloader of the mobile device.

2. The method of claim 1, wherein the potential unauthorized access includes a removal of the first user as an authorized user of the mobile device.

3. The method of claim 2, wherein an authorization to send the instruction that locks the bootloader of the mobile device is enabled for the first user and disabled for all other users.

4. The method of claim 2, wherein an authorization to send the instruction that locks the bootloader of the mobile device is disabled for the first user after the predefined time period.

5. The method of claim 1, further comprising determining the first user based on an authorized user prior to the potential unauthorized access.

6. The method of claim 1, wherein the potential unauthorized access includes adding a second user as an authorized user.

7. The method of claim 1, wherein the potential unauthorized access includes a reset of the mobile device.

8. The method of claim 1, wherein the potential unauthorized access includes wiping a storage of the mobile device.

9. The method of claim 1, wherein the confirmation of the unauthorized access requires authenticating the first user at a device management portal.

10. The method of claim 9, wherein said sending the instruction that locks the bootloader of the mobile device includes sending a passcode for locking the mobile device, and wherein the first user may retrieve the passcode from the device management portal.

11. The method of claim 1, further comprising determining that the mobile device is in a powered-off state, and wherein the instruction that locks the bootloader of the mobile device is sent upon the mobile device entering a powered-on state and connecting to a network.

12. The method of claim 1, wherein the instruction that locks the bootloader of the mobile device overrides an access control by an operating system of the mobile device, the access control configured by a second user.

13. The method of claim 1, wherein the instruction that locks the bootloader of the mobile device occurs while the mobile device is in a secure state set by an operating system of the mobile device.

14. The method of claim 13, wherein the secure state includes an access controlled state requiring user authentication to access the mobile device.

15. The method of claim 13, wherein the secure state includes encrypting a storage of the mobile device.

16. The method of claim 1, wherein the bootloader of the mobile device is provided by a first entity that manufactured the mobile device, and an operating system of the mobile device is provided by a second entity that remotely secures the mobile device.

17. A system for remotely securing a mobile device, comprising:
a database storing usage information of the mobile device; and
a server coupled to the database, the server comprising a processor, the processor configured to:
determine a potential unauthorized access of the mobile device based on the stored usage information;
send, to a first user, a notification of the potential unauthorized access;
receive, from the first user, a confirmation of an unauthorized access, the confirmation received within a predefined time period of sending the notification; and
send, to the mobile device and in response to the confirmation, an instruction that locks a bootloader of the mobile device.

18. The system of claim 17, wherein the processor is further configured to:
determine that the mobile device is in a powered-off state;
store the instruction that locks the bootloader of the mobile device in the database; and wherein the instruction that locks the bootloader of the mobile device is sent upon determining that the mobile device is in a powered-on state and connected to a network.

19. A method of remotely securing a mobile device, comprising:
authenticating, at a device management portal, a first user of the mobile device;
receiving, from the first user, a request to lock the mobile device; and
sending, to the mobile device and in response to the request, an instruction that locks a bootloader of the mobile device.

20. The method of claim 19, further comprising determining the first user has authorization to send the instruction that locks the bootloader of the mobile device.

21. The method of claim 19, wherein the instruction that locks the bootloader of the mobile device overrides an access control by an operating system of the mobile device.
